(19) United States
(12) Patent Application Publication
(10) Pub. No.: US 2024/0195520 A1
(43) Pub. Date: Jun. 13, 2024

(54) NETWORK DEVICE AND NETWORK PACKET PROCESSING METHOD

(71) Applicant: Realtek Semiconductor Corp., HsinChu (TW)

(72) Inventor: Hou-Wei Lee, HsinChu (TW)

(73) Assignee: Realtek Semiconductor Corp., HsinChu (TW)

(21) Appl. No.: 18/500,147

(22) Filed: Nov. 2, 2023

(30) Foreign Application Priority Data
Dec. 8, 2022 (TW) 111147122

(51) Int. Cl. H04J 3/06

(52) U.S. Cl. CPC H04J 3/0667; H04J 3/067

(57) ABSTRACT

A network packet processing method includes: by a processor of the network device, generating a first predetermined packet, and providing the first predetermined packet to a core circuit of a network device; by a packet parser of the core circuit, parsing the first predetermined packet to obtain a first parsing result corresponding to the first predetermined packet, generating a control information corresponding to the first predetermined packet according to the first parsing result, and providing the first predetermined packet and the control information to a front-end processing circuit; and by the front-end processing circuit, obtaining a first transmitting timestamp corresponding to the first predetermined packet in response to reception of the first predetermined packet, determining to write the first transmitting timestamp into the first predetermined packet or a register according to the control information, and transmitting the first predetermined packet.

### BACKGROUND OF THE INVENTION

### 1. Field of the Invention

The present invention is related to a network device for performing precision time synchronization, and more particularly, to a network device that can effectively reduce a delay caused by time synchronization while reducing complexity of a processing circuit.

### 2. Description of the Prior Art

Precision time protocol (PTP) is a protocol that can synchronize times between two devices. Multiple PTP packets may be transmitted between the two devices to exchange transmitting (TX) timestamps and receiving (RX) timestamps for calculating a time difference between the two devices. After one of the two devices corrects the time difference, the times of the two devices can be the same.

Since the types of packets transmitted between the two devices are not limited to the PTP packets only, PTP signal processing performed upon all TX packets and RX packets will increase a packet transmission delay. More particularly, in some applications with strict requirements for the packet transmission delay (e.g., Ultra-Reliable and Low Latency Communications (URLLC) service in a 5G mobile network), the packets for a user plane from a service endpoint to another service endpoint should be transmitted within 1 millisecond (ms), wherein uplink and downlink transmission each take 0.5 ms. As a result, low-latency circuit design is necessary in these applications.

### SUMMARY OF THE INVENTION

It is therefore one of the objectives of the present invention to provide a network device that can effectively reduce a delay caused by time synchronization while reducing complexity of an internal processing circuit, to address the above-mentioned issues.

According to an embodiment of the present invention, a network device is provided. The network device comprises a front-end processing circuit, a core circuit, and a processor. The front-end processing circuit is arranged to receive a first predetermined packet from a network interface, and comprises a receiving signal processing circuit. The receiving signal processing circuit is arranged to obtain a receiving timestamp corresponding to the first predetermined packet in response to reception of the first predetermined packet, generate first time information corresponding to the first predetermined packet according to the receiving timestamp, and provide the first predetermined packet and the first time information to the core circuit. The core circuit comprises a packet parser and a packet modifier. The packet parser is arranged to parse the first predetermined packet to obtain a first parsing result, and determine whether to record the first time information according to the first parsing result. In response to the first time information being recorded, the packet modifier is arranged to store the first time information, and provide the first determined packet to a processor. The processor is arranged to obtain the first time information, and obtain the receiving timestamp according to first time information.

According to another embodiment of the present invention, a network device is provided. The network device comprises a processor, a core circuit, and a front-end processing circuit. The processor is arranged to generate a first predetermined packet, and provide the first predetermined packet to the core circuit. The core circuit comprises a packet parser. The packet parser is arranged to parse the first predetermined packet to obtain a first parsing result, generate control information corresponding to the first predetermined packet according to the first parsing result, and provide the first predetermined packet and the control information to the front-end processing circuit. The front-end processing circuit comprises a transmitting signal processing circuit. The transmitting signal processing circuit is arranged to obtain a transmitting timestamp corresponding to the first predetermined packet in response to reception of the first predetermined packet, determine to write the transmitting timestamp into the first predetermined packet or a register according to the control information, and transmit the first predetermined packet.

According to another embodiment of the present invention, a network packet processing method applied to a network device is provided. The network packet processing method comprises: by a processor of the network device, generating a first predetermined packet, and providing the first predetermined packet to a core circuit of the network device; by a packet parser of the core circuit, parsing the first predetermined packet to obtain a first parsing result corresponding to the first predetermined packet, generating control information corresponding to the first predetermined packet according to the first parsing result, and providing the first predetermined packet and the control information to a front-end processing circuit; and by the front-end processing circuit, obtaining a first transmitting timestamp corresponding to the first predetermined packet in response to reception of the first predetermined packet, determining to write the first transmitting timestamp into the first predetermined packet or a register according to the control information, and transmitting the first predetermined packet.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a network device according to an embodiment of the present invention.

FIG. 2 is a diagram illustrating a PTP packet transmission flow.

FIG. 3 is a diagram illustrating a packet processing flow on a receiving path according to an embodiment of the present invention.

FIG. 4 is a diagram illustrating a packet processing flow on a transmitting path according to an embodiment of the present invention.

FIG. 5 is a diagram illustrating a packet processing flow on a receiving path according to another embodiment of the present invention.

FIG. 6 is a diagram illustrating a packet processing flow on a transmitting path according to another embodiment of the present invention.

FIG. 7 is a flow chart of a network packet processing method according to an embodiment of the present invention.

### DETAILED DESCRIPTION

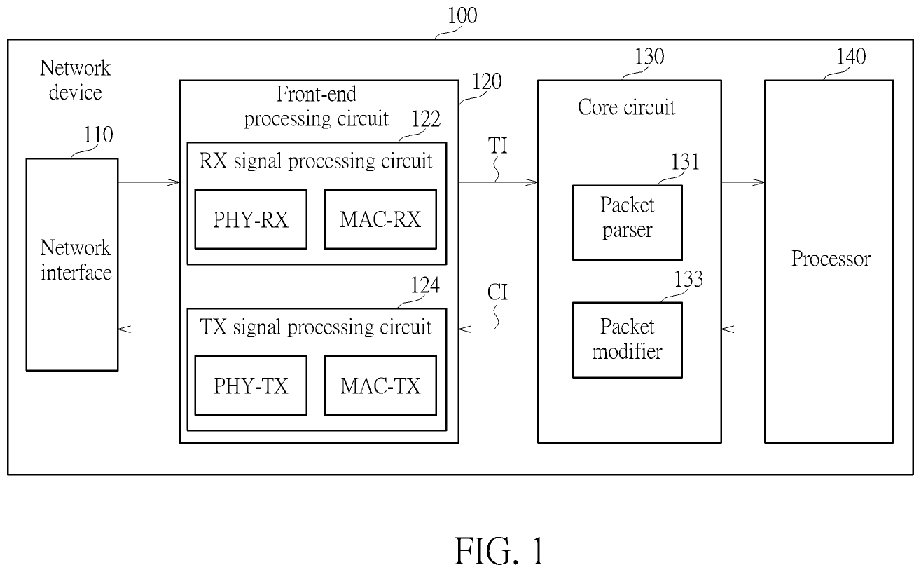

FIG. 1 is a block diagram of a network device 100 according to an embodiment of the present invention. The network device 100 may be a switch or a router, and may include a network interface 110, a front-end processing circuit 120, a core circuit 130, and a processor 140. The network interface 110 may be a port for coupling a network cable or an optical fiber. The front-end processing circuit 120 may be arranged to process signals received and transmitted by the network interface 110, and may include a receiving (RX) signal processing circuit 122 for processing RX signals and a transmitting (TX) signal processing circuit 124 for processing TX signals.

The RX signal processing circuit 122 may include a physical (PHY) layer RX signal processing circuit (labeled “PHY-RX” in FIG. 1 for brevity) and a media access control (MAC) layer RX signal processing circuit (labeled “MAC-RX” in FIG. 1 for brevity). The PHY layer RX signal processing circuit may be arranged to perform PHY signal processing (e.g., PHY signal processing in an open system interconnection (OSI) model) upon an RX path according to a corresponding communications protocol. The MAC layer RX signal processing circuit may be arranged to perform MAC layer signal processing upon the RX path according to the corresponding communications protocol.

The TX signal processing circuit 124 may include a PHY layer TX signal processing circuit (labeled “PHY-TX” in FIG. 1 for brevity) and a MAC layer TX signal processing circuit (labeled “MAC-TX” in FIG. 1 for brevity). The PHY layer TX signal processing circuit may be arranged to perform PHY signal processing upon a TX path according to the corresponding communications protocol. The MAC layer TX signal processing circuit may be arranged to perform MAC layer signal processing upon the TX path according to the corresponding communications protocol.

In some embodiments, the front-end processing circuit 120 may be implemented to include a PHY layer signal processing chip and a MAC layer signal processing chip, wherein the PHY layer signal processing chip is arranged to process TX signals and RX signals (e.g., data frames of Ethernet) according to a corresponding PHY layer communications protocol, and may include the PHY layer RX signal processing circuit and the PHY layer TX signal processing circuit. The MAC layer signal processing chip is arranged to process TX signals and RX signals according to a corresponding MAC layer communications protocol (e.g., add control information to data as the TX signal provided to the PHY layer signal processing chip, and remove the control information from the RX signal provided by the PHY layer signal processing chip and provide the processed RX signal to a next-level signal processing circuit), and may include the MAC layer RX signal processing circuit and the MAC layer TX signal processing circuit. The front-end processing circuit 120 shown in FIG. 1 is only a schematic diagram for separately explaining the signal processing of the TX path and the RX path, and is not meant to be a limitation of an internal configuration of the front-end processing circuit 120.

In some embodiments, there may be a SERializer-DESerializer (SERDES; not shown in FIG. 1) between the PHY layer RX signal processing circuit and the MAC layer RX signal processing circuit, wherein the SERDES is arranged to convert a high-speed serial signal into a low-speed parallel signal. In addition, there may also be a SERDES (not shown in FIG. 1) between the PHY layer TX signal processing circuit and the MAC layer TX signal processing circuit, wherein the SERDES is arranged to convert the low-speed parallel signal into the high-speed serial signal. In some embodiments, there may be a SERDES chip between the PHY layer signal processing chip and the MAC layer signal processing chip, wherein the SERDES chip is arranged to perform bidirectional conversion between the low-speed parallel signal and the high-speed serial signal. FIG. 1 is a schematic diagram of a simplified network device, in which only components relevant to the present invention are shown. Those skilled in the art can understand that a network device can include other components not shown in FIG. 1 to implement wired or wireless communications and related signal processing functions.

In some embodiments, the front-end processing circuit 120 may only include the MAC layer signal processing circuit (which includes the RX signal processing circuit and the TX signal processing circuit) or the MAC layer signal processing chip, and may not include circuits or a chip related to the PHY layer. For example, when the network interface 110 of the network device 100 is implemented as a network interface for configuring a copper port, the front-end processing circuit 120 may include the MAC signal processing circuit and the PHY layer signal processing circuit, and the signal transmission media is copper. When the network interface 110 of the network device 100 is implemented as a network interface for configuring a fiber port, the front-end processing circuit 120 may only include the MAC signal processing circuit. The front-end processing circuit 120 shown in FIG. 1 is only one embodiment of the present invention, and the present invention is not limited thereto.

The core circuit 130 is coupled between the front-end processing circuit 120 and the processor 140, and is arranged to perform other signal processing required by the network device 100. For example, the core circuit 130 may include a packet parser 130 for parsing a packet to extract contents carried by the packet and a packet modifier 133 for modifying the content of the packet (e.g., writing data into the packet). In an embodiment of the present invention, the core circuit 130 may also be implemented as a network device core chip. In the embodiment shown in FIG. 1, the processor 140 is an external processor for the core circuit 130, but the present invention is not limited thereto. In another embodiment of the present invention, the processor 140 may be included in the core circuit 130.

As mentioned above, during the network communications, multiple precision time protocol (PTP) packets are transmitted between two network devices to exchange TX timestamps and RX timestamps for calculating a time difference between the two network devices, wherein one of the two network devices is a master network device, and another of the two network devices is a slave network device. After the slave network device modifies the time difference, the times of the two network devices can be the same (i.e., the times can be synchronized).

In this embodiment, the network device 100 of the present invention is equipped with a novel configuration, which can effectively reduce the delay caused by time synchronization, and can reduce the complexity of an internal processing circuit. The network device 100 may be the master network device or the slave network device, i.e. configuration provided by the present invention not only can be applied to the slave network device but can also be applied to the master network device. In addition, since the network device of the present invention will not change the necessary PTP packet transmission behavior when performing the time synchronization between two devices, the network device proposed by the present invention can also be used with an existing network device to complete the time synchronization.

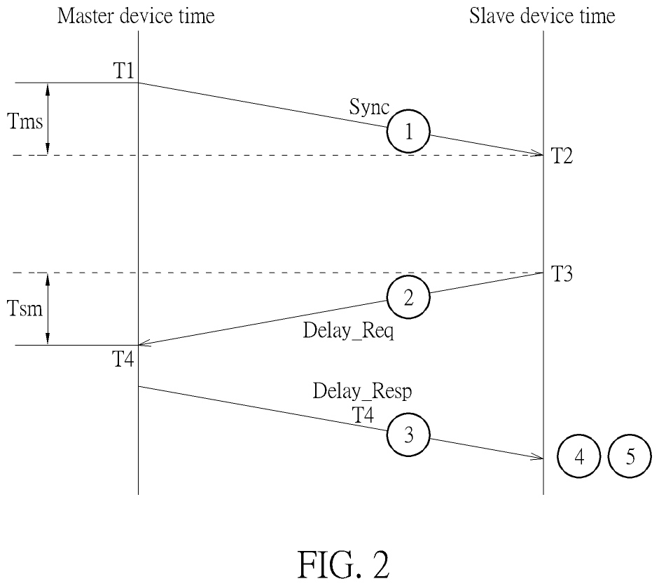

FIG. 2 is a diagram illustrating a PTP packet transmission flow, wherein a time axis of the master network device (labeled “Master device time”), a time axis of the slave network device (labeled “Slave device time”), and corresponding operations in the PTP packet transmission flow (labeled numbers 1-5 circled in circles) are illustrated.

In an operation 1, the master network device transmits a packet Sync carrying information of a time T1 to the slave network device, wherein the time T1 is a TX time of the packet Sync. When the slave network device receives the packet Sync, an RX time T2 of the packet Sync is recorded, and the time T1 is obtained from the packet Sync.

In an operation 2, the slave network device transits a packet Delay_Req to the master network device, and records a TX time T3 of the packet Delay_Req. After the master network device receives the packet Delay_Req, an RX time T4 of the packet Delay_Req is recorded.

In an operation 3, the master network device transmits a packet Delay_Resp carrying information of the RX time T4 to the slave network device. After the slave network device receives the packet Delay_Resp, the RX time T4 is obtained from the packet Delay_Resp. At this moment, the slave network device has obtained information of times T1, T2, T3 and T4.

Assume that a time Tms represents a time for transmitting a packet from the master network device to the slave network device, and a time Tsm represents a time for transmitting a packet from the slave network device to the master network device. Under this condition, Tms=(T2−T1), and Tsm=(T4−T3).

In an operation 4, the slave network device may calculate an average value D of the times Tms and Tsm. For example, D=(Tms+Tsm)/2=((T4−T1)−(T3−T2))/2.

In an operation 5, assume that delays of bidirectional paths of the master network device and the slave network device are the same, and a time difference Offset between the master network device and the slave network device is equal to T2−T1−D (i.e., Offset=T2−T1−D). The slave network device may subtract the time difference Offset from a clock time maintained by itself (e.g., the clock time maintained by the processor of the slave network device), for synchronizing the clock time maintained by the slave network device with the clock time maintained by the master network device.

In order to realize the above-mentioned flow, hardware of the network device should be equipped with the following abilities:
1. Timestamping: for example, when a packet is received, the RX time is stamped. When a packet is transmitted, the TX time is stamped.
2. Packet parsing: for example, a header of a packet is parsed to obtain related information for message type of the packet, wherein in the header of the packet, values of a message type field represent different message types. For example, the value “0” corresponds to the packet Sync, the value “1” corresponds to the packet Delay_Req, and the value “2” corresponds to the packet Delay_Resp. In this way, the RX side can identify different packets.
3. Time information processing: since different types of packets may require different types of time information processing (e.g., storing the timestamp in a register or writing the timestamp into a packet), the network device performs corresponding time information processing depending on the message type of the packet.

In a conventional design, the signal processing required by the PTP packet will be performed upon all TX packets and RX packets. Under a condition that different types of packets not limited to PTP packets are transmitted between two network devices, the conventional design will greatly increase the packet transmission delay, and the complexity of the internal processing circuit is increased.

In order to address this issue, the present invention utilizes a novel configuration of PTP packet processing to effectively reduce the delay caused by time synchronization, and reduce the complexity of the internal processing circuit.

Refer back to FIG. 1. According to an embodiment of the present invention, during processing of the RX packet, the RX signal processing circuit 122 of the front-end processing circuit 120 may obtain an RX timestamp corresponding to a predetermined packet from the network interface 110 in response to reception of the predetermined packet, generate time information TI corresponding to the predetermined packet according to the RX timestamp, and provide the predetermined packet and the time information TI to the core circuit 130. In other words, after obtaining the RX timestamp and the time information TI, the front-end processing circuit 120 may transmit the packet to the subsequent circuit (e.g., the core circuit 130) without performing PTP-related processing upon the received packet.

The packet parser 133 of the core circuit 130 may parse the predetermined packet to obtain a parsing result including the message type of the predetermined packet, and determine whether to record the time information TI according to the parsing result.

When the network device is the master network device, the predetermined packet received by the network device can be the packet Delay_Req. When the network device is the slave master network device, the predetermined packet received by the network device can be the packet Sync or the packet Delay_Resp. For the packet Delay_Resp, the network device does not need to record the time information TI (i.e., information of the RX timestamp).

In response to the time information TI being recorded, the packet modifier 133 may be arranged to store the time information TI and provide the predetermined packet to the processor 140. In one embodiment, the packet modifier 133 may write the time information TI into a reserved field of the predetermined packet, or write the time information TI into a register accessible to the processor 140. The operation of writing the time information TI into the register may be performed by other devices included in the core circuit 130. The processor 140 may obtain the time information TI from the reserved field of the predetermined packet or the register, and obtain the RX timestamp corresponding to the predetermined packet according to the time information TI.

During a process of the TX packet, the processor 140 generates the predetermined packet to be transmitted, and provides the predetermined packet to the core circuit 130. The packet parser 131 of the core circuit 130 parses the predetermined packet to obtain a parsing result corresponding to the predetermined packet, generates control information CI corresponding to the predetermined packet according to the parsing result, and provides the control information CI to the front-end processing circuit 120.

In response to the reception of the predetermined packet, the TX signal processing circuit 124 of the front-end processing circuit 120 obtains a TX timestamp corresponding to the predetermined packet, determines to write the TX timestamp into the predetermined packet or another register according to the control information CI, and transmits the predetermined packet thorough the network interface 110.

When the network device is the slave network device, the predetermined packet transmitted by the network device can be the packet Delay_Req. When the network device is the master network device, the predetermined packet transmitted by the network device can be the packet Sync or the packet Delay_Resp. For the packet Sync, the network device is required to write the TX timestamp into the predetermined packet in order to make the predetermined packet carry TX time information of the packet Sync (e.g., the time T1 shown in FIG. 2). For the packet Delay_Req, the network device is required to store the TX timestamp (e.g., the time T3 shown in FIG. 2) in the register without making the predetermined packet carry the TX time information of the packet Delay_Req. For the packet Delay_Resp, the network device is required to make the packet Delay_Resp carry RX time information of the packet Delay_Resp (e.g., the time T4 shown in FIG. 2).

In addition, when the network device is the slave network device, in a case where the received predetermined packet is determined to be the packet Sync, the processor 140 may obtain the RX timestamp (e.g., the time T2 shown in FIG. 2) according to the time information TI corresponding to the predetermined packet, and parse the predetermined packet to obtain the TX timestamp (e.g., the time T1 shown in FIG. 2). In a case where the received predetermined packet is determined to be the packet Delay_Resp, the processor 140 may obtain a timestamp carried by the predetermined packet (i.e., the RX timestamp of the packet Delay_Req, such as the time T4 shown in FIG. 2) by parsing the predetermined packet, and adjust the clock time maintained by the processor 140 according to the TX timestamp corresponding to the packet Sync, the RX timestamp corresponding to the packet Sync, the TX timestamp corresponding to the packet Delay_Req, and the RX timestamp of the packet Delay_Req carried by the packet Delay_Resp.

In this embodiment, for the RX packet, the front-end processing circuit 120 only needs to perform timestamp processing to obtain corresponding time information TI. For the TX packet, the front-end processing circuit 120 only needs to perform the timestamp processing and process the time information TI according to the control information CI. The front-end processing circuit 120 may include an internal clock circuit. When the timestamp processing is performed, the front-end processing circuit 120 may obtain a current time from the internal clock circuit as the corresponding timestamp. For example, when a start of frame delimiter is detected to be transmitted or received, the front-end processing circuit 120 may obtain the current time from the internal clock circuit as the corresponding TX/RX timestamp.

In this embodiment, the front-end processing circuit 120 does not perform the packet parsing and the time information processing upon the RX path, and does not perform the packet parsing upon the TX path. As a result, compared with the conventional design, the present invention can effectively reduce delay caused by packet processing and reduce complexity of the front-end processing circuit 120. In addition, a packet processing range of the packet parser 131 and the packet modifier 133 in the core circuit 130 exceeds a valid field position of the PTP packet. As a result, by establishment and transmission of the time information TI and the control information CI, the packet parsing and time information processing operation on the RX path and the packet parsing operation on the TX path are modified to be performed by the core circuit 130, so that the delay caused by packet processing will not be added to the core circuit 130. The design of the core circuit 130 is reused due to the parsing and packet modification function, which can effectively reduce the hardware costs of the network device.

When the network interface 110 of the network device 100 is implemented by a network interface with a copper port, the front-end processing circuit 120 may include a PHY layer signal processing circuit and an MAC layer signal processing circuit. When the network interface 110 of the network device 100 is implemented by a network interface with a fiber port, the front-end processing circuit 120 may include a MAC layer signal processing circuit. As a result, in different embodiments of the present invention, the timestamp processing and generation of the time information TI may be performed by the PHY layer signal processing circuit or the MAC layer signal processing circuit.

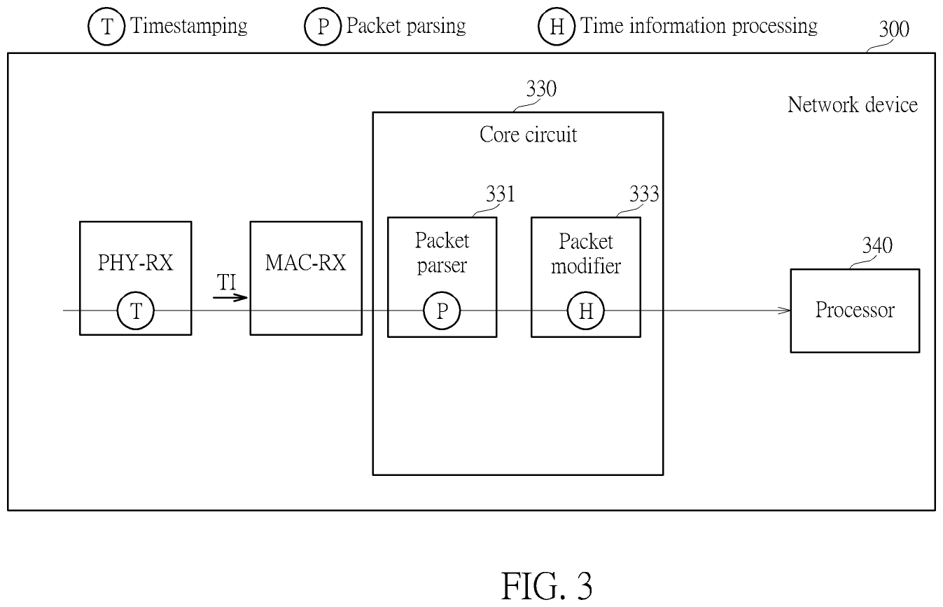

FIG. 3 is a diagram illustrating a packet processing flow on a RX path according to an embodiment of the present invention. In this embodiment, a front-end processing circuit of a network device 300 may include a PHY layer signal processing circuit and a MAC layer signal processing circuit, and the timestamp processing and generation of the time information TI may be performed by the PHY layer signal processing circuit.

When a PHY layer RX signal processing circuit (labeled “PHY-RX” in FIG. 3) of the front-end processing circuit receives a packet, the timestamp processing is performed to obtain an RX timestamp (denoted by “T” in FIG. 3), the time information TI is generated according to the RX timestamp, and the time information TI is provided to a MAC layer RX signal processing circuit (labeled “MAC-RX” in FIG. 3). The MAC layer RX signal processing circuit may transmit the time information TI to a core circuit 330 through a bus. The RX timestamp may be information with a first number of bits (e.g. 78 bits including second information with 48 bits and nanosecond (ns) information with 30 bits). The time information TI may be complete timestamp information or simplified timestamp information. For example, the time information TI may be information with a second number of bits, wherein the second number of bits is smaller than the first number of bits, and the second number of bits may be information with 32 bits including second information with 2 bits and nanosecond information with 30 bits.

For example, the PHY layer RX signal processing circuit may convert the RX time into a value in units of nanosecond, and then divide by 2³² (i.e., perform the calculation “(SEC*10\hat{ }9+NSEC) % (2\hat{ }32)”) to obtain the time information TI with 32 bits, wherein SEC is the value of the second part of the RX time, and NSEC is the value of the nanosecond part of the RX time.

The time information TI may be carried by the start of the packet transmission. For example, the time information TI may be carried by the preamble of the packet, but the present invention is not limited thereto. After the core circuit 330 receives the packet, a packet parser 331 in the core circuit 330 may parse the packet (denoted by “P” in FIG. 3) to determine whether the packet is a PTP packet. In response to the packet being the PTP packet, the packet parser 331 may be further arranged to obtain a PTP header format of the packet by parsing the packet, and inform a packet modifier 333 in the core circuit 330 for corresponding processing. The packet modifier 333 may perform the time information processing according to a parsing result (denoted by “H” in FIG. 3). For example, depending on the message type of the packet, the packet modifier 333 may perform the corresponding time information processing. According to an embodiment of the present invention, the packet modifier 333 may write the time information TI into the reserved field of the predetermined packet or a register accessible to a processor 340.

After receiving the packet, the processor 340 may obtain the time information TI by parsing the packet or accessing the register, and calculate the RX time (i.e., the value of the RX timestamp) according to a current clock time of the PTP packet (e.g., perform the calculation “[diff=(CUR_SEC*10\hat{ }9+CUR_NSEC) % 2\hat{ }32−TI]”), wherein CUR_SEC is the value in seconds part of the current time, and CUR_NSEC is the value in nanosecond part of the current time. The processor 340 may subtract the value of diff from the current time to obtain the RX time of the packet.

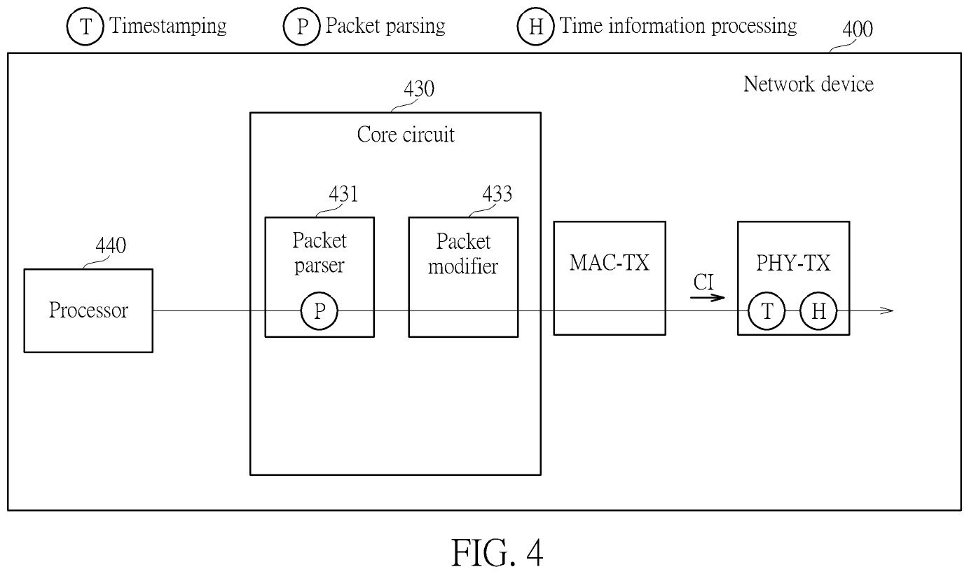

FIG. 4 is a diagram illustrating a packet processing flow on a TX path according to an embodiment of the present invention. In this embodiment, a front-end processing circuit of a network device 400 may include a PHY layer signal processing circuit and a MAC layer signal processing circuit, and the timestamp and time information processing may be performed by the PHY layer signal processing circuit.

During a process of the TX packet, a processor 440 may generate a packet to be transmitted, and provide the packet to a core circuit 430. After the core circuit 430 receives the packet, a packet parser 431 in the core circuit 430 may parse the packet (denoted by “P” in FIG. 4). If the TX port of the network device 400 enables the PTP function and the packet parser 431 determines that the packet is a PTP packet to be processed according to the message type, the control information CI is transmitted to the PHY layer TX signal processing circuit. In addition, the control information CI may be carried by the start of the packet transmission (e.g. may be carried by the preamble of the packet), but the present invention is not limited thereto.

According to an embodiment of the present invention, the control information CI may include (but is not limited to) the following information:
(a) information indicating whether to make the TX time (i.e., the value of the TX timestamp) be carried by a timestamp field of the packet;
(b) information indicating whether to add the TX time to a value of a modification field;
(c) information indicating whether to store the TX time into a register, wherein the register may be a first in first out (FIFO) register for recording the timestamp; and
(d) a starting position of a header file of the packet (e.g., a byte offset); wherein each of information a−c may be a setting value with one bit, and information d may be a value with multiple bits.

When receiving the packet and the control information CI, the PHY layer TX signal processing circuit may perform the timestamp operation (denoted by “T” in FIG. 4) and parse the control information CI, to determine the subsequent time information processing (denoted by “H” in FIG. 4), wherein the subsequent time information processing may include an operation for making the TX time be carried by the timestamp field of the packet and an operation for storing the TX time into a register. Afterwards, the PHY layer TX signal processing circuit may transmit the packet through the network interface.

For example, assume that the network device 400 is a master network device for transmitting the packet Sync. The processor 440 may generate the packet Sync and provide the packet Sync to the core circuit 430. The packet parser 431 may parse the packet to determine whether the packet is a PTP packet to be processed, calculate the starting position of the header file of the packet (e.g., a starting byte), and arrange the control information CI according to a parsing result.

Assume that the packet Sync is a one step packet. Since the one step packet is required to inform the PHY layer TX signal processing circuit for writing the TX time into the timestamp field of the packet, the control information CI may be set as follows:
a=1 (the TX time is required to be carried by the timestamp field of the packet);
b=0 (there is no need to add the TX time to the value of the modification field);
c=0 (there is no need to store the TX time into the register); and
d=7 (under a condition that the byte offset value is in a unit of 2 bytes and the header file of the packet starts from the fifteenth byte, the byte offset value=(14/2)=7 can be obtained).

When receiving the packet and the control information CI, the PHY layer TX signal processing circuit may perform the timestamp operation and read the control information CI. Since (a=1, d=7), the PHY layer TX signal processing circuit may skip (7*2+34) bytes and write the TX time into the timestamp field of the packet, wherein the 34 bytes are the PTP header size, and the timestamp field is a field next to the PTP header file.

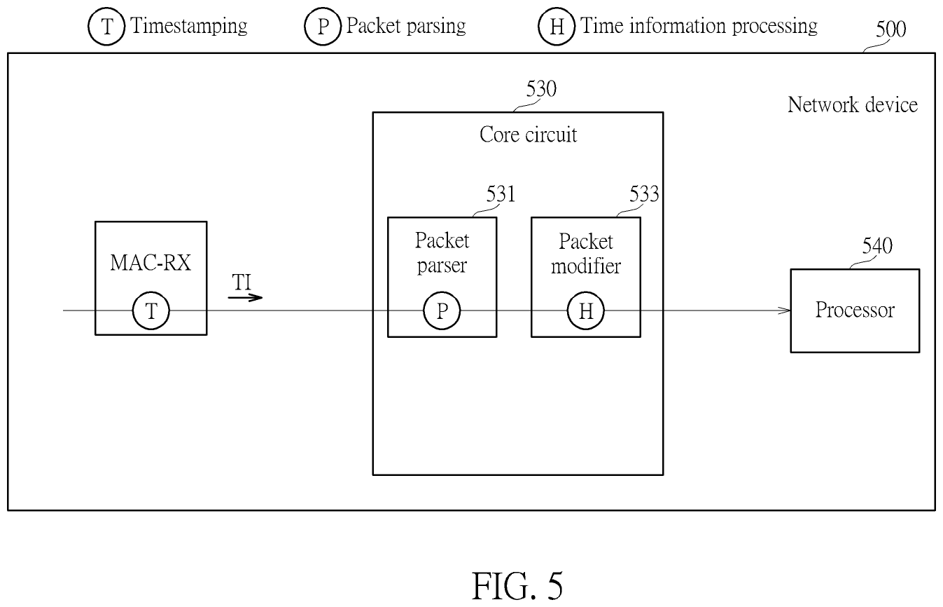

FIG. 5 is a diagram illustrating a packet processing flow on an RX path according to another embodiment of the present invention. In this embodiment, a front-end processing circuit of a network device 500 may only include a MAC layer signal processing circuit. The MAC layer signal processing circuit may be arranged to perform the timestamp processing, generate the corresponding time information TI, and provide the time information TI to a core circuit 530 through a bus.

When a MAC layer RX signal processing circuit of the front-end processing circuit receives a packet, the timestamp processing is performed to obtain an RX timestamp (denoted by “T” in FIG. 5), the time information TI is generated according to the RX timestamp, and the time information TI is transmitted to the core circuit 530 through the bus. The RX timestamp may be information with a first number of bits (e.g. 78 bits including second information of 48 bits and ns information of 30 bits). The time information TI may be complete timestamp information or simplified timestamp information. For example, the time information TI may be information of a second number of bits, wherein the second number of bits is smaller than the first number of bits, and the second number of bits may be information of 32 bits including second information of 2 bits and nanosecond information of 30 bits.

For example, the MAC layer RX signal processing circuit may convert the RX time into a value in a unit of nanosecond, and then divide by2³²(i.e., perform the calculation “(SEC*10\hat{ }9 +NSEC) % (2\hat{ }32)”) to obtain the time information TI with 32 bits, wherein SEC is the value of the second part of the RX time, and NSEC is the value of the nanosecond part of the RX time.

The time information TI may be carried by the start of the packet transmission. For example, the time information TI may be carried by the preamble of the packet, but the present invention is not limited thereto. After the core circuit 530 receives the packet, a packet parser 531 in the core circuit 530 may parse the packet (denoted by “P” in FIG. 5) to determine whether the packet is a PTP packet. In response to the packet being the PTP packet, the packet parser 531 may be further arranged to obtain a PTP header format of the packet by parsing the packet, and inform a packet modifier 533 in the core circuit 530 for corresponding processing. The packet modifier 533 may perform the time information processing according to a parsing result (denoted by “H” in FIG. 5). For example, depending on the message type of the packet, the packet modifier 533 may perform the corresponding time information processing. According to an embodiment of the present invention, the packet modifier 533 may write the time information TI into the reserved field of the predetermined packet or a register accessible to a processor 540.

After receiving the packet, the processor 540 may obtain the time information TI by parsing the packet or accessing the register, and calculate the RX time (i.e., the value of the RX timestamp) according to a current clock time of the PTP packet (e.g. perform the calculation “[diff=(CUR_SEC*10\hat{ }9+CUR_NSEC) % 2\hat{ }32−TI]”), wherein CUR_SEC is the value in seconds part of the current time, and CUR_NSEC is the value in nanosecond part of the current time. The processor 540 may subtract the value of diff from the current time to obtain the RX time of the packet.

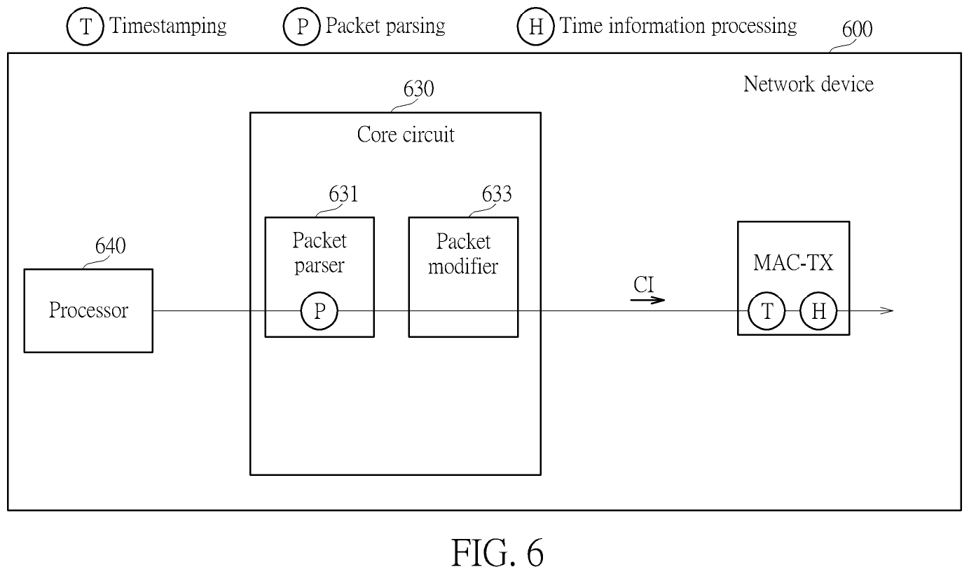

FIG. 6 is a diagram illustrating a packet processing flow on a TX path according to another embodiment of the present invention. In this embodiment, a front-end processing circuit of a network device 600 may only include a MAC layer signal processing circuit, and the timestamp and time information processing may be performed by the MAC layer signal processing circuit.

During a process of the TX packet, a processor 640 may generate a packet to be transmitted, and provide the packet to a core circuit 630. After the core circuit 630 receives the packet, a packet parser 631 in the core circuit 630 may parse the packet (denoted by “P” in FIG. 6). If the TX port of the network device 600 enables the PTP function and the packet parser 631 determines that the packet is a PTP packet to be processed according to the message type, the control information CI is transmitted to the MAC layer TX signal processing circuit. The control information CI may be transmitted through the bus, but the present invention is not limited thereto. The information that can be included in the control information CI can be known by referring to the description in the above paragraphs.

When receiving the packet and the control information CI, the MAC layer TX signal processing circuit may perform the timestamp operation (denoted by “T” in FIG. 6) and parse the control information CI to determine the subsequent time information processing (denoted by “H” in FIG. 6), wherein the subsequent time information processing may include an operation for making the TX time be carried by the timestamp field of the packet and an operation for storing the TX time into a register. Afterwards, the MAC layer TX signal processing circuit may transmit the packet through the network interface.

The difference between FIG. 4 and FIG. 6 is that the device that receives the packet and the control information CI and performs the timestamp operation and the time information processing is modified from the PHY layer TX signal processing circuit to the MAC layer TX signal processing circuit. For brevity, similar descriptions are not repeated in detail here.

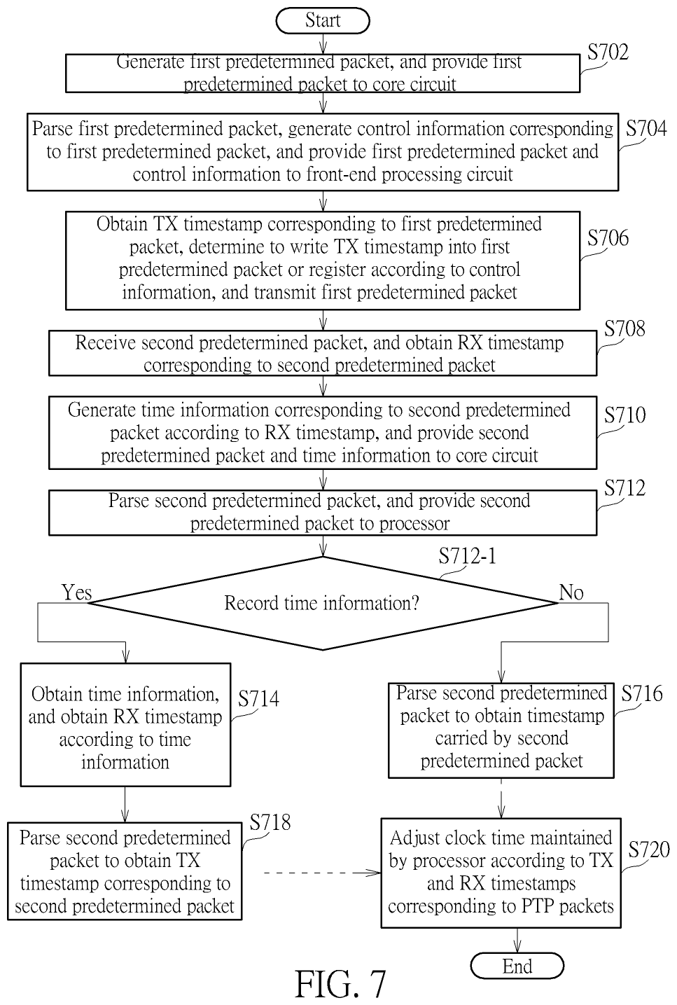

FIG. 7 is a flow chart of a network packet processing method according to an embodiment of the present invention, wherein the network packet processing method is applicable to a network device (e.g. the network device 100 shown in FIG. 1), and the network device may be a master network device or a slave network device. The network packet processing method may include the following steps performed by internal components of the network device.

In Step S702, by a processor of the network device, a first predetermined packet is generated and provided to a core circuit of the network device.

In Step S704, by a packet parser of the core circuit, the first predetermined packet is parsed to obtain a parsing result corresponding to the first predetermined packet, control information corresponding to the first predetermined packet is generated according to the parsing result, and the first predetermined packet and the control information are provided to a front-end processing circuit of the network device.

In Step S706, by the front-end processing circuit, in response to reception of the first predetermined packet, a TX timestamp corresponding to the first predetermined packet is obtained, the TX timestamp is determined to be written into the first predetermined packet or a register according to the control information, and the first predetermined packet is transmitted.

In addition, when the packet is received, the network packet processing method can further include the following steps performed by internal components of the network device.

In Step S708, by the front-end processing circuit, a second predetermined packet is received from a network interface, and an RX timestamp corresponding to the second predetermined packet is obtained in response to reception of the second predetermined packet.

In Step S710, by the front-end processing circuit, time information corresponding to the second predetermined packet is generated according to the RX timestamp, and the second predetermined packet and the time information are provided to the core circuit.

In Step S712, by the core circuit, the second predetermined packet is parsed to obtain a parsing result, it is determined whether to record the time information according to the parsing result (Step S712-1), and the second predetermined packet is provided to the processor. In response to the time information being recorded, the time information is stored by the core circuit, and Step S714 is entered. In response to the time information not being recorded, Step S716 is entered.

In Step S714, by the processor, the time information is obtained, and the RX timestamp corresponding to the second predetermined packet is obtained according to the time information.

In Step S716, by the processor, a timestamp carried by the second predetermined packet is obtained by parsing the second predetermined packet.

It should be noted that the TX operation and the RX operation of the network packet processing method may be performed alternately or repeatedly, and the ordinal numbers “first” and “second” are not used to limit the order of the packets that are transmitted or received.

In an embodiment of the present invention, when the network device is a slave network device, under a condition that the second predetermined packet is determined to be the packet Sync, the network packet processing method may further include the following steps (e.g., Step S718).

In Step S718, by the processor, the second predetermined packet is parsed to obtain a TX timestamp corresponding to the second predetermined packet.

In an embodiment of the present invention, when the network device collects the time information corresponding to all of the PTP packets, the network packet processing method may further include the following steps performed by the processor (e.g., Step S720).

In Step S720, the clock time maintained by the processor is adjusted according to the TX and RX timestamps corresponding to the PTP packets (e.g. the TX and RX timestamps corresponding to the packet Sync and the TX and RX timestamps corresponding to the packet Delay_Req).

By establishment and transmission of the time information TI and the control information CI, the packet parsing and time information processing operation on the RX path and the packet parsing operation on the TX path are modified to be performed by the core circuit 130, so that the delay caused by packet processing will not be added to the core circuit 130. Further, the design of the core circuit 130 is reused due to the parsing and packet modification function, which can effectively reduce the hardware costs of the network device. In addition, the configuration and the network packet processing method proposed by the present invention can be applied to a master network device or a slave network device, and can be applied to different network devices in the network communications, such as an ordinary clock device, a boundary clock device, and a transparent clock device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network device, comprising:
a front-end processing circuit, arranged to receive a first predetermined packet from a network interface, comprising:
a receiving signal processing circuit, arranged to obtain a receiving timestamp corresponding to the first predetermined packet in response to reception of the first predetermined packet, generate a first time information corresponding to the first predetermined packet according to the receiving timestamp, and provide the first predetermined packet and the first time information to a core circuit;
the core circuit, comprising:
a packet parser, arranged to parse the first predetermined packet to obtain a first parsing result, and determine whether to record the first time information according to the first parsing result; and
a packet modifier, wherein in response to the first time information being recorded, the packet modifier is arranged to store the first time information, and provide the first determined packet to a processor; and
the processor, wherein in response to the first time information being recorded, the processor is arranged to obtain the first time information, and obtain the receiving timestamp according to first time information.

2. The network device of claim 1, wherein the first predetermined packet is a precision time protocol (PTP) packet.

3. The network device of claim 1, wherein the receiving signal processing circuit comprises a physical (PHY) layer receiving signal processing circuit, the receiving timestamp is obtained by the PHY layer receiving signal processing circuit, and the first time information is generated by the PHY layer receiving signal processing circuit.

4. The network device of claim 1, wherein the receiving signal processing circuit comprises a media access control (MAC) layer receiving signal processing circuit, the receiving timestamp is obtained by the MAC layer receiving signal processing circuit, the first time information is generated by the MAC layer receiving signal processing circuit, and the first predetermined packet and the first time information are provided to the core circuit through a bus.

5. The network device of claim 1, wherein the receiving timestamp is represented by a first number of bits, the receiving signal processing circuit simplifies the first number of bits to generate the first time information represented by a second number of bits, and the second number of bits is smaller than the first number of bits.

6. The network device of claim 1, wherein the front-end processing circuit further comprises:
a transmitting signal processing circuit, arranged to receive a second predetermined packet and a control information corresponding to the second predetermined packet, obtain a first transmitting timestamp corresponding to the second predetermined packet in response to reception of the second predetermined packet, determine to write the first transmitting timestamp into the second predetermined packet or a register according to the control information, and transmit the second predetermined packet.

7. The network device of claim 6, wherein the processor parses the first predetermined packet to obtain a second transmitting timestamp corresponding to the first predetermined packet; the front-end processing circuit receives a third predetermined packet, and provides the third predetermined packet to the core circuit; the core circuit parses the third predetermined packet to generate a second parsing result, determines whether to record a second time information corresponding to the third predetermined packet according to the second parsing result, and provides the third predetermined packet to the processor; and in response to the second time information being not recorded, the processor parses the third predetermined packet to obtain a timestamp carried by the third predetermined packet, and adjusts a clock time maintained by the processor according to the receiving timestamp, the first transmitting timestamp, the second transmitting timestamp, and the timestamp.

8. The network device of claim 7, wherein the first parsing result comprises a message type of the first predetermined packet, and the second parsing result comprises a message type of the third predetermined packet.

9. A network device, comprising:
a processor, arranged to generate a first predetermined packet, and provide the first predetermined packet to a core circuit;
the core circuit, comprising:
a packet parser, arranged to parse the first predetermined packet to obtain a first parsing result, generate a control information corresponding to the first predetermined packet according to the first parsing result, and provide the first predetermined packet and the control information to a front-end processing circuit; and
the front-end processing circuit, comprising:
a transmitting signal processing circuit, arranged to obtain a transmitting timestamp corresponding to the first predetermined packet in response to reception of the first predetermined packet, determine to write the transmitting timestamp into the first predetermined packet or a register according to the control information, and transmit the first predetermined packet.

10. The network device of claim 9, wherein the first predetermined packet is a precision time protocol (PTP) packet.

11. The network device of claim 9, wherein the transmitting signal processing circuit comprises a physical (PHY) layer transmitting signal processing circuit, and the transmitting timestamp is obtained by the PHY layer transmitting signal processing circuit.

12. The network device of claim 9, wherein the transmitting signal processing circuit comprises a media access control (MAC) layer transmitting signal processing circuit, the transmitting timestamp is obtained by the MAC layer transmitting signal processing circuit, and the first predetermined packet and the control information are provided to the MAC layer transmitting signal processing circuit through a bus.

13. The network device of claim 9, wherein the front-end processing circuit further comprises:
a receiving signal processing circuit, arranged to receive a second predetermined packet from a network interface, obtain a receiving timestamp corresponding to the second predetermined packet in response to reception of the second predetermined packet, generate a time information corresponding to the second predetermined packet according to the receiving timestamp, and provide the second predetermined packet and the time information to the core circuit;
wherein the packet parser parses the second predetermined packet to obtain a second parsing result, and determine whether to record the time information according to the second parsing result; and the core circuit further comprises:
a packet modifier, wherein in response to the time information being recorded, the packet modifier stores the time information, and provides the second predetermined packet to the processor;
wherein in response to the time information being recorded, the processor obtains the time information, and obtains the receiving timestamp according to the time information.

14. The network device of claim 13, wherein the processor generates a third predetermined packet, and writes the receiving timestamp into the third predetermined packet.

15. The network device of claim 14, wherein the second parsing result comprises a message type of the second predetermined packet, and a parsing result corresponding to the third predetermined packet comprises a message type of the third predetermined packet.

16. A network packet processing method, applied to a network device, comprising:
by a processor of the network device, generating a first predetermined packet, and providing the first predetermined packet to a core circuit of the network device;
by a packet parser of the core circuit, parsing the first predetermined packet to obtain a first parsing result corresponding to the first predetermined packet, generating a control information corresponding to the first predetermined packet according to the first parsing result, and providing the first predetermined packet and the control information to a front-end processing circuit; and
by the front-end processing circuit, obtaining a first transmitting timestamp corresponding to the first predetermined packet in response to reception of the first predetermined packet, determining to write the first transmitting timestamp into the first predetermined packet or a register according to the control information, and transmitting the first predetermined packet.

17. The network packet processing method of claim 16, further comprising:
by the front-end processing circuit, receiving a second predetermined packet from a network interface, and obtaining a receiving timestamp corresponding to the second predetermined packet in response to reception of the second predetermined packet;
by the front-end processing circuit, generating a first time information corresponding to the second predetermined packet according to the receiving timestamp, and providing the second predetermined packet and the first time information to the core circuit;
by the core circuit, parsing the second predetermined packet to obtain a second parsing result, determining whether to record the first time information according to the second parsing result, and providing the second predetermined packet to the processor, wherein in response to the first time information being recorded, the first time information is stored by the core circuit; and
by the processor, in response to the first time information being recorded, obtaining the first time information, and obtaining the receiving timestamp according to the first time information.

18. The network packet processing method of claim 17, further comprising:
by the processor, parsing the second predetermined packet to obtain a second transmitting timestamp corresponding to the second predetermined packet;
by the front-end processing circuit, receiving a third predetermined packet from the network interface, and providing the third predetermined packet to the core circuit;
by the core circuit, parsing the third predetermined packet to generate a third parsing result, determining whether to record a second time information corresponding to the third predetermined packet according to the third parsing result, and providing the third predetermined packet to the processor; and
by the processor, in response to the second time information not being recorded, parsing the third predetermined packet to obtain a timestamp carried by the third predetermined packet, and adjusting a clock time maintained by the processor according to the receiving timestamp, the first transmitting timestamp, the second transmitting timestamp, and the timestamp.

19. The network packet processing method of claim 17, wherein the receiving timestamp is represented by a first number of bits, the first time information is represented by a second number of bits, and the first time information is generated by simplifying the first number of bits, wherein the second number of bits is smaller than the first number of bits.

20. The network packet processing method of claim 18, wherein the first predetermined packet, the second predetermined packet, and the third predetermined packet are precision time protocol (PTP) packets with different message types.
